(19) United States
(12) Patent Application Publication
(10) Pub. No.: US 2011/0074306 A1
(43) Pub. Date: Mar. 31, 2011

(54) LED DIMMING APPARATUS, CIRCUIT, AND METHOD THEREOF

(75) Inventor: WEI-TING TAI, Guishan Township (TW)

(73) Assignee: HUIYANG TECHNOLOGY CO., LTD.

(21) Appl. No.: 12/753,953

(22) Filed: Apr. 5, 2010

(30) Foreign Application Priority Data
Sep. 30, 2009 (TW) 98133204

(51) Int. Cl. H05B 37/02

(52) U.S. Cl. 315/287

(57) ABSTRACT

Disclosed is a LED dimming apparatus, which uses a conventional light modulator in conjunction with a rectification circuit, an active matching circuit, an analog/digital converter circuit and a pulse width modulation circuit to control brightness of a LED light source apparatus. The conventional light modulator produces a dimming signal. The matching circuit connects to the light modulator for receiving the dimming signal to convert it to a matching signal with the lowest output current. The analog/digital converter circuit connects to the matching circuit for receiving the matching signal and converting it to a conversion signal with positive half cycles of a sinusoidal waveform. The pulse width modulation circuit connects to the analog/digital converter circuit for receiving the conversion signal and producing a pulse width modulation signal with a stable output current. The LED light source apparatus connects to the LED dimming apparatus, receiving the modulation signal to control the brightness.

### BACKGROUND OF THE INVENTION

1. Field of the Invention

The present invention relates to a LED dimming apparatus, in particular, to a dimming apparatus concentrating on LED light sources.

2. Description of Related Art

As technology advances, as well as the trend of energy saving, all kinds of lamps and a variety of new types of light sources are developed continuously, for example, from the traditional incandescent bulbs to the latest white LED elements. With the expanded application range of these light sources, such as, stage lighting or home lighting and so on, all kinds of dimming apparatuses for adjusting the brightness level of light have also been widely applied. However, the drive modes of different light sources are not the same, and therefore, these dimming apparatuses also must be improved and adapted for a variety of light sources correspondingly.

Conventional light sources, such as incandescent light sources, have the general service life of 1,000 hours or more. Incandescent light sources are the most widely applied light source for an ordinary family or in commercial use. A new type of light source, such as LED (Light Emitting Diode) light source, has a service life up to 100,000 hours, and also has both advantages of energy-saving and short reaction time. With the energy-saving issue prevailing, LED light sources have also become progressively more appealing and popular.

FIG. 1 illustrates a schematic diagram of the dimming apparatus in accordance with the conventional light source apparatus.

A conventional dimming apparatus 1 primarily focuses on performing illumination brightness adjustment of a conventional light source apparatus 12. Generally, the aforementioned conventional light source apparatus 12 is the incandescent light source. The conventional light source apparatus 12 can be triggered and emits light by applying the public electricity (AC power signal) and AC signals, therefore, it's merely required to add a light modulator 11 between the AC power source 10 and the conventional light source apparatus 12 so as to provide illumination brightness adjustment for the conventional light source apparatus 12 via applying the light modulator 11.

Generally speaking, the light modulator 11 can be a TRIAC (Triode for Alternating Current) or a SCR (Silicone Controlled Rectifier), or even a simple rheostat to achieve the objective of adjusting illumination brightness of the conventional light source apparatus 12 by regulating the current value, voltage level, or phase angle of the input AC power source. Because the conventional light source apparatus 12 can be triggered by applying AC signals directly, the output signal of the light modulator 11 is an AC signal.

FIG. 2 illustrates a schematic diagram of the dimming apparatus in accordance with the conventional LED light source apparatus.

A LED light source apparatus 24 is a kind of apparatus by taking LED's as its light source. Because LED light sources cannot be Illuminated by AC power, though they emit light by applying DC power sources, it can not utilize AC signals to drive directly unlike the conventional filament-illuminating light source. Therefore, it is necessary to add an analog/digital converter 21 (AC to DC converter, ADC) between the AC power source 10 and the LED light source apparatus 24 so as to convert AC power signals to DC power signals, thereby driving the LED light source apparatus 24 smoothly. However, the current conversion circuit is commercially available, for example, for the incandescent lamp of the stabilizer without supporting for the power signal conversion functions, such that the public can not replace the conventional incandescent light sources into a variety of new types of LED light sources directly.

Furthermore, simply driving the LED light source apparatus 24 to emit light can not satisfy requirements in use completely, a dimming function must be added so as to meet applications at home, in commercial, display settings, or on stage. Therefore, the rear side of the light modulator as shown in FIG. 1 connects with a conventional LED dimming circuit 25 to convert AC signals to DC signals and perform dimming operations for the LED light source apparatus 24. Therein, the conventional LED dimming circuit 25 and the light modulator 11 can be composed or arranged to be a conventional LED dimming apparatus 2, wherein the conventional LED dimming circuit 25 includes an analog/digital converter circuit 21, a pulse width modulation circuit 22 and a pulse width modulated control signal circuit 23.

The light modulator 11 of the conventional LED dimming apparatus 2 connects with the AC power source 10 for receiving the AC power signal of the AC power source 10 and performing current, voltage, and phase adjustment of the AC power source 10 so as to form a dimming signal. The analog/digital converter circuit 21 connects with the light modulator 11 for receiving the dimming signal of the light modulator 11 and performing analog to digital conversion so as to generate a DC conversion signal. The pulse width modulation circuit 22 connects with the analog/digital converter circuit 21 and the pulse width modulated control signal circuit 23 for receiving the conversion signal of the analog/digital converter circuit so as to generate a pulse width modulation signal. Finally, the conventional LED light source apparatus 24 connects with the pulse width modulation circuit 22 for receiving the pulse width modulation signal to drive the LED light source apparatus 24 for emitting light. Therein, the pulse width modulation circuit 22 generally utilizes a DC/DC converted pulse width modulation circuit for receiving and taking the DC conversion signal as a reference voltage level of outputting conversion signals, and for receiving and taking the pulse width modulated control signal of the pulse width modulated control signal circuit 23 as a reference duty cycle of outputting conversion signals.

FIG. 3 illustrates a signal diagram of the dimming apparatus in accordance with the conventional LED light source apparatus.

The AC power signal of the AC power source 10 is usually the sinusoidal wave or cosine wave, herein, the sinusoidal wave is taken as an embodiment for illustration. Please refer to FIG. 2 in conjunction with FIG. 3, as the light modulator 11 receives the AC power signal of the AC power source 10, users can regulate the light modulator 11 to generate a dimming signal. In general, the light modulator 11 can be classified into several types based on modulating voltage, current and phase of AC power signals; herein, a phase type light modulator 11 is taken as an embodiment for illustration. Therefore, while the light modulator 11 receives the AC power signal of the AC power source 10 and generates a dimming signal having the successive half cycles of the positive sinusoidal half-cycle waveform and the successive half cycles of the negative sinusoidal half-cycle waveform, the analog/digital converter circuit 21 receives the dimming signal and then generates a conversion signal with DC voltage after rectification, voltage transformation and voltage stabilization are processed by the analog/digital converter circuit 21 the pulse width modulation circuit 22 receives the conversion signal and is cooperated with the pulse width modulated control signal outputted from the pulse width modulated control signal circuit 23 so as to generate a pulse width modulation signal. Therein, the pulse width modulation circuit 22 can regulate the illumination brightness of the LED light source apparatus 24 by adjusting the voltage level or duty cycle ratio of the pulse width modulation signal.

The conventional LED light source apparatus 23 can apply the commonly seen light regulators 11 in combination with the conventional dimming circuit to form a conventional LED dimming apparatus 2 and produce a pulse width modulation signal so as to trigger the LED light source apparatus 24. However, as the conduction angle of the light modulator 11 is modulated to be too small, the current value of the dimming signal generated from different brands, specifications and standards of light regulators will be too small as well. Consequently, if the analog/digital converter circuit 21 receives the current value of the dimming signal which is lower than the threshold value of operating current thereof, the conversion signal outputted from the analog/digital converter circuit 21 is unstable; if the pulse width modulation circuit 22 receives the conversion signal with the current value lower than the threshold value of operating current associated with the pulse width modulation circuit 22, the pulse width modulation signal outputted from the pulse width modulation circuit 22 is a unstable signal. The unstable conversion signal and the pulse width modulation signal cause the LED light source apparatus 24 twinkle or simply become non-functional. Additionally, the DC/DC converted pulse width modulation circuit 22 is applied according to the prior art. This kind of pulse width modulation circuit 22 does not have transformer coils, thus does not have the isolation effect, and therefore, it would result in a leakage problem for the conventional LED light source apparatus 24.

### SUMMARY OF THE INVENTION

To solve the aforementioned issues, an embodiment of a LED dimming apparatus according to the present invention, comprising: a light modulation, connected with a AC power source, for receiving a AC power signal and generating a dimming signal; a rectification circuit, connected with the light modulator, for receiving the dimming signal and rectifying the dimming signal to generate a rectification signal; a matching circuit, connected with the light modulator, for receiving the rectification signal and matching the rectification signal to generate a matching signal respectively; an analog/digital converter circuit, connected with the matching circuit, for receiving the matching signal and converting the matching signal to form a conversion signal with positive half cycles of a sinusoidal waveform; and a pulse width modulation circuit, connected with the analog/digital converter circuit, for receiving the conversion signal, generating a modulation signal according to the conversion signal, and transferring the modulation signal to a LED light source apparatus so as to drive the LED light source apparatus emitting light.

To solve the aforementioned issues, an embodiment of a LED dimming circuit according to the present invention, comprising: a matching circuit, connected with the light modulator, for receiving a dimming signal of the light modulator and converting the dimming signal to a matching signal; an analog/digital converter circuit, connected with the matching circuit, for receiving the matching signal and converting the matching signal to form a conversion signal with positive half cycles of a sinusoidal waveform; and a pulse width modulation circuit, connected with the analog/digital converter circuit, for receiving the conversion signal, generating a modulation signal according to the conversion signal, and transferring the modulation signal to a LED light source apparatus so as to drive the LED light source apparatus emitting light.

To solve the aforementioned issues, an embodiment of a LED dimming method according to the present invention, comprising: providing a light modulator, for generating a dimming signal; providing a matching circuit, for generating a matching signal based on the dimming signal and generating the matching signal with the lowest output current value based on various dimming signals, in which the lowest output current value that is fixed at the output current value with a conduction angle greater than zero degree; providing an analog/digital converter circuit, for generating a conversion signal based on the matching signal which has a conversion signal with positive half cycles of a sinusoidal waveform; and providing a pulse width modulation circuit, for generating a pulse width modulation signal based on the signal period and the voltage level of the conversion signal so as to drive a LED light source apparatus, wherein the pulse width modulation signal has a constant output current value, so that the LED light source apparatus has a stable luminescence spectrum.

The concepts of the present invention as invented by the inventor are distinguishable from the standard technology according to the prior art. Accordingly, a LED dimming apparatus is provided so as to utilize the light modulator of the prior art and the LED dimming apparatus of the present invention, thereby performing dimming for LED light source apparatuses and promoting industrial upgrading.

In order to further understand the techniques, means and effects the present invention takes for achieving the prescribed objectives, the following detailed description and included drawings are hereby referenced, such that, through which, the purposes, features and aspects of the present invention can be thoroughly and concretely appreciated; however, the included drawings are provided solely for reference, explanation, and illustration, without any intention that they be used for limiting the present invention.

### BRIEF DESCRIPTION OF THE DRAWINGS

FIG. 1 illustrates a schematic diagram of the dimming apparatus in accordance with the conventional light source apparatus;

FIG. 2 illustrates a schematic diagram of the dimming apparatus in accordance with the conventional LED light source apparatus;

FIG. 3 illustrates a signal diagram of the dimming apparatus in accordance with the conventional LED light source apparatus;

FIG. 4 illustrates a schematic diagram of a first embodiment of the LED dimming apparatus in accordance with the present technique;

FIG. 5 illustrates a signal diagram of the first embodiment of the LED dimming apparatus in accordance with the present technique;

FIG. 6 illustrates a schematic diagram of a second embodiment of the LED dimming apparatus in accordance with the present technique; and

FIG. 7 illustrates a signal diagram of the second embodiment of the LED dimming apparatus in accordance with the present technique.

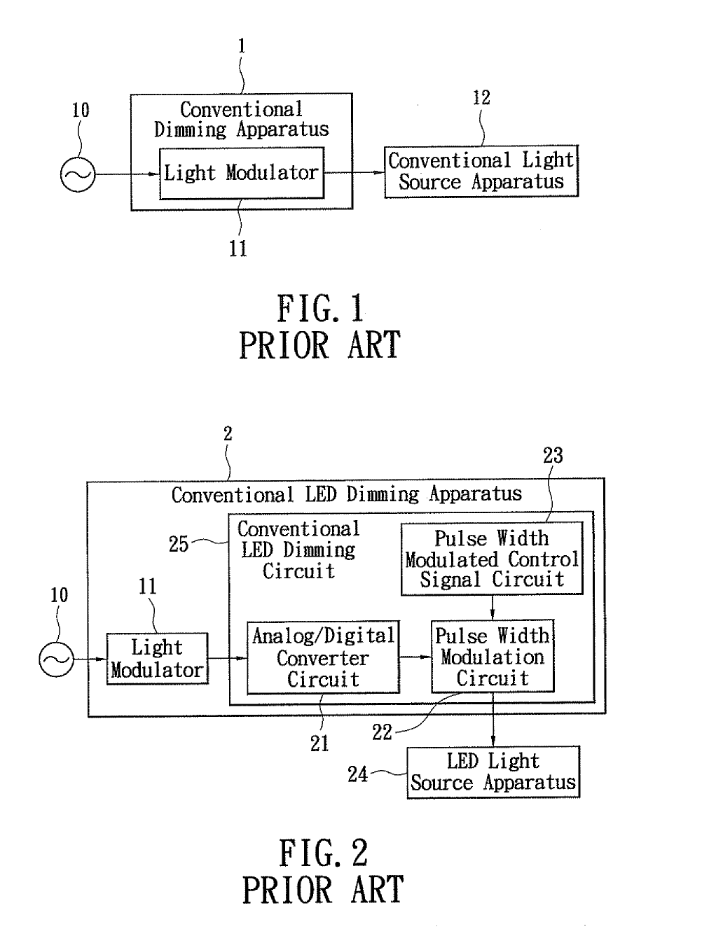

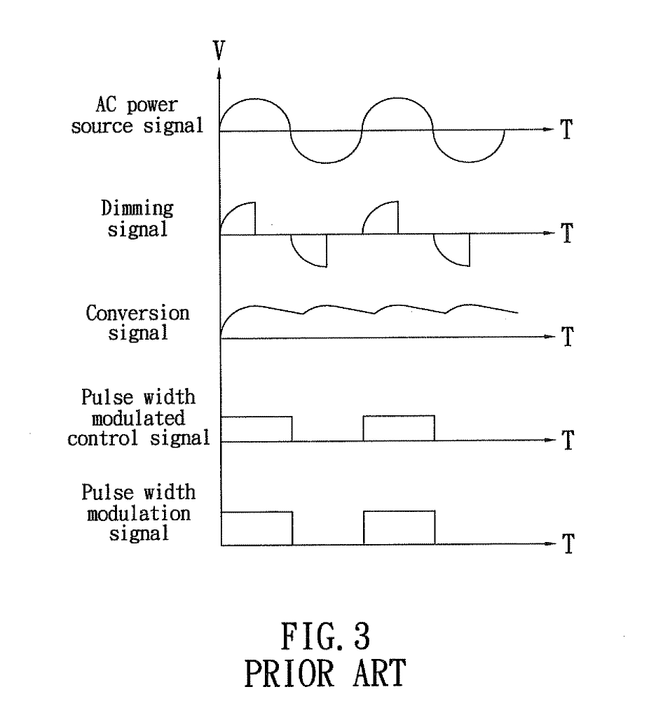

### DETAILED DESCRIPTION OF THE PREFERRED EMBODIMENTS

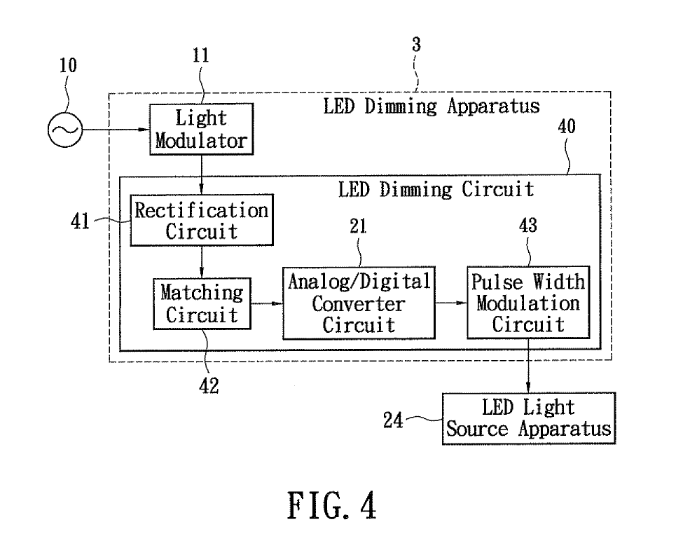

FIG. 4 illustrates a schematic diagram of a first embodiment of the LED dimming apparatus in accordance with the present technique.

The LED dimming apparatus 3 includes a light modulator 11, a rectification circuit 41, an active matching circuit 42, an analog/digital converter circuit 21 and a pulse width modulation circuit 43. The light modulator 11 connects with the AC power source 10 to receive AC power signals and perform adjustment for AC power signal current value, voltage level and phase angle of the AC power source 10 so as to generate a dimming signal. With regard to the embodiment, the light modulator 11 for regulating the phase angle of the AC power signal is taken as an embodiment for illustration. The rectification circuit 41 connects with the light modulator 11 to receive the dimming signal and rectify the dimming signal to generate a rectification signal. The active matching circuit 42 connects with the rectification circuit 41 to receive the rectification signal and perform signal matching for the rectification signal to form a matching signal. The analog/digital converter circuit 21 connects with the matching circuit 42 to receive the matching signal and perform the analog to digital conversion to generate a DC conversion signal. The pulse width modulation circuit 43, connects with the analog/digital conversion circuit 21 to receive the conversion signal of the analog/digital conversion circuit 21 and form a pulse width modulation signal based on the voltage level and the duty cycle of the conversion signal. Lastly, the LED dimming apparatus 3 drives the LED light source apparatus 24 based on the pulse width modulation signal generated. Therein, the rectification circuit 41 can be integrated with the light modulator 11, or with the matching circuit 42, so that the matching circuit 42 can either receive the rectified dimming signal or receive the dimming signal directly in advance and then perform rectification afterward inside the matching circuit. Thus, the rectification circuit 31, the matching circuit 42, the analog/digital conversion circuit 21 and the pulse width modulation circuit 43 is configured to be a LED dimming circuit 40. Additionally, the light modulator 11 can be a TRIAC or a SCR light modulator.

Therefore, the light modulator 11 is the conventional light modulator which has a large number of brands and different specifications and standards, and even dimming signals generated and output current values for a variety of light modulators 11 in different conduction angles are not the same. As a result, the light modulator 11 fails to generate a dimming signal having the same specifications and standards, and results in the signal modulation which is required to perform specifically for each of different standards of light modulators 11 as shown in FIG. 2, so as to modulate the LED light source apparatus 24 successfully.

Thus, the first embodiment of the present invention utilizes the active matching circuit 42 based on the variation of the dimming signal in accordance with the light modulator 11 to perform full-wave rectification for the dimming signal. And when the light modulation configures in a lower conduction angle, which is below than 20 degrees, the matching circuit 42 is going to fix the output current value as the conduction angle is at 20 degrees, so as to allow the matching signal containing the lowest output current value, such that the analog/digital converter circuit 21 or the pulse width modulation circuit 43 can receive the matching signal with the lowest operating current required respectively to maintain the normal operation state thereof. For the aforementioned reasons, the matching circuit 42 is designed to perform modulation in the output current value actively for the dimming signals generated from all different kinds of the light modulators 11, thereby adapting for all light modulators with different brands, specifications, and standards. Herein, the active matching circuit 42 can be any one kind of matching circuits, primarily utilizing a configuration containing a voltage unit (not shown), a control unit (not shown) and a current unit (not shown) to perform matching and modulation of the dimming signal, so that the light modulator 11 is able to output the matching signal with the lowest operating current in all phases and all operating voltages, and the matching circuit, connected with the analog/digital converter circuit 21 and the pulse width modulation circuit 43, are capable of operating normally, thereby adjusting brightness of the LED light source apparatus 24 ordinarily.

In addition, based on the first embodiment of the present invention, the pulse width modulation circuit 43 of the LED dimming circuit 40 is an AC/DC pulse width modulation circuit 43, which can utilize the conversion signal generated from the analog/digital conversion circuit 21 to form the corresponding pulse width modulation signal. In other words, the pulse width modulation circuit 43 can take the period of the conversion signal as the reference duty cycle of the pulse width modulation signal and take the waveform variation of the conversion signal as the reference output voltage of the pulse width modulation signal. Furthermore, because the AC to DC pulse width modulation circuit 43 contains transformer coils, and thus has an isolation effect, which means that the front end signal variation of the pulse width modulation circuit 43 and the pulse width modulation signal generated from the rear end thereof contains an isolation effect, the leakage problem of the LED power source apparatus 24 can be prevented.

It is worth mentioning that, the first embodiment of the present invention, the pulse width modulation circuit 43 of the LED dimming circuit 40 outputs the pulse width modulation signal as a high voltage and constant current pulse width modulation signal. As the output voltage of the pulse width modulation voltage is higher than the drive voltage of the LED light source apparatus 23, the LED's of the LED light source apparatus 24 can be activated completely. While the pulse width modulation signal outputted is maintained at a constant current value, the LED's of the LED light source apparatus 23 has a stable luminescence spectrum. Therefore, according to the dimming apparatus 40 of the first embodiment in accordance with the present invention can contain a function to drive the LED light source apparatus 24 regularly and prevent drift for the luminescence spectrum of the LED light source due to instable current.

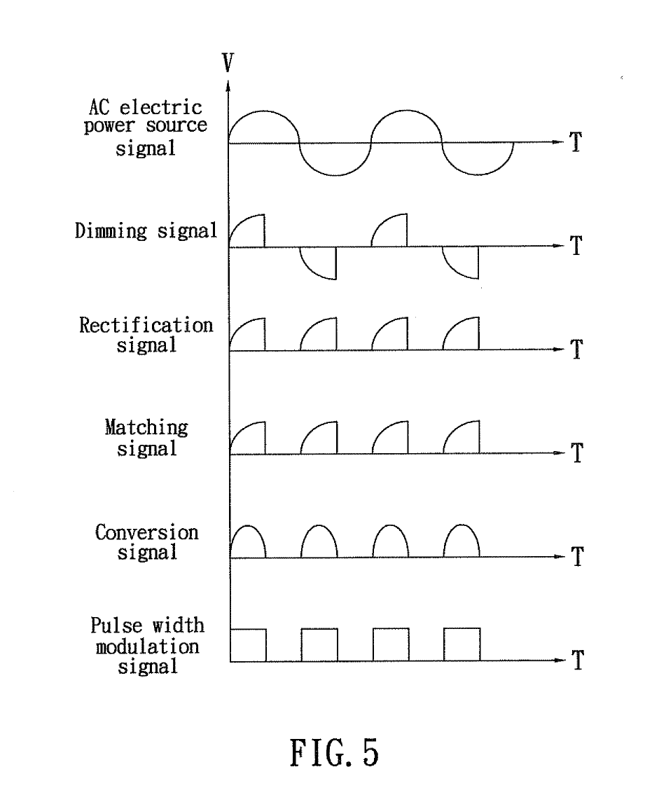

FIG. 5 illustrates a signal diagram of the first embodiment of the LED dimming apparatus in accordance with the present technique.

The AC power signals of the AC power source 10 are normally the sinusoidal wave or cosine wave, and the embodiment takes the sinusoidal wave as an example. Please refer to FIG. 4 in conjunction with FIG. 5, the light modulator 11 connects with the AC power source 10 to receive an AC power signal and perform phase regulation for the AC power signal. As per the example of the phase type light modulator 11 of the embodiment, a dimming signal having the successive half cycles of the positive sinusoidal half-cycle waveform and the successive half cycles of the negative sinusoidal half-cycle waveform is generated. The rectification circuit 41 connects with the light modulator 11 to receive the dimming signal and perform signal rectification, so as to convert the negative half cycle signals into the positive half cycle signals to generate a rectification signal. The active matching circuit 42 connects with the rectification circuit 41 to receive the rectification signal and perform full-wave rectification to generate a matching signal with the successive half cycles of the positive sinusoidal half-cycle waveform, wherein the matching signal contains the same of operating frequency and maximum output voltage level of the rectification signal. Additionally, the matching signal has the lowest output current value, for example, as the conduction angle of the light modulator 11 modulates to be below 20 degrees, the output current value is fixed at the current value for the conduction angle of 20 degrees, and thus is guaranteed that the subsequent analog/digital converter circuit 21 and the pulse width modulation circuit 43 are capable of receiving the matching signal or the conversion signal with the lowest operating current value. The analog/digital converter circuit 21 connects to the active matching circuit 42 to receive the matching signal and output a conversion signal having the successive half cycles of the positive sinusoidal half cycle waveform via the internal transformer elements (not shown) and the rectifier elements (not shown), wherein the conversion signal and the matching signal have the same duty cycle and the maximum output voltage level. The pulse width modulation circuit 43 connects with the analog/digital converter circuit 21 to receive the conversion signal and generate a pulse width modulation signal according to the maximum output voltage level and the duty cycle of the conversion signal, wherein the pulse width modulation signal has a high voltage, which is higher than the operating voltage of the LED light source apparatus 24, and a constant output current, which can stable the luminescent chromaticity generated by the LED light source apparatus 24, thereby preventing drift for the luminescence spectrum of the LED light source.

As a result, according to the LED dimming apparatus 3 of the first embodiment in accordance with the prevent invention, as the light modulator 11 has the maximum conduction angle, the dimming signal of the light regulator 11 has the sinusoidal wave entirely, the rectification circuit converts the negative half cycle wave of the dimming signal into the positive half cycle wave thereof to generate a rectification signal, the matching circuit 42 and the analog/digital converter circuit 21 generate the matching signal and the conversion signal containing the same waveform of the dimming signal, and finally, the waveform of the pulse width modulation signal associated with the pulse width modulation circuit 43 approaches a DC output voltage. Contrarily, if the conduction angle of the dimming signal outputted from the light modulator is getting smaller, the waveform ratio of the sinusoidal wave in accordance with the dimming signal is getting smaller as shown in FIG. 5, wherein the matching signal and the conversion signal are maintained to have the successive half cycles of the positive sinusoidal half-cycle waveform.

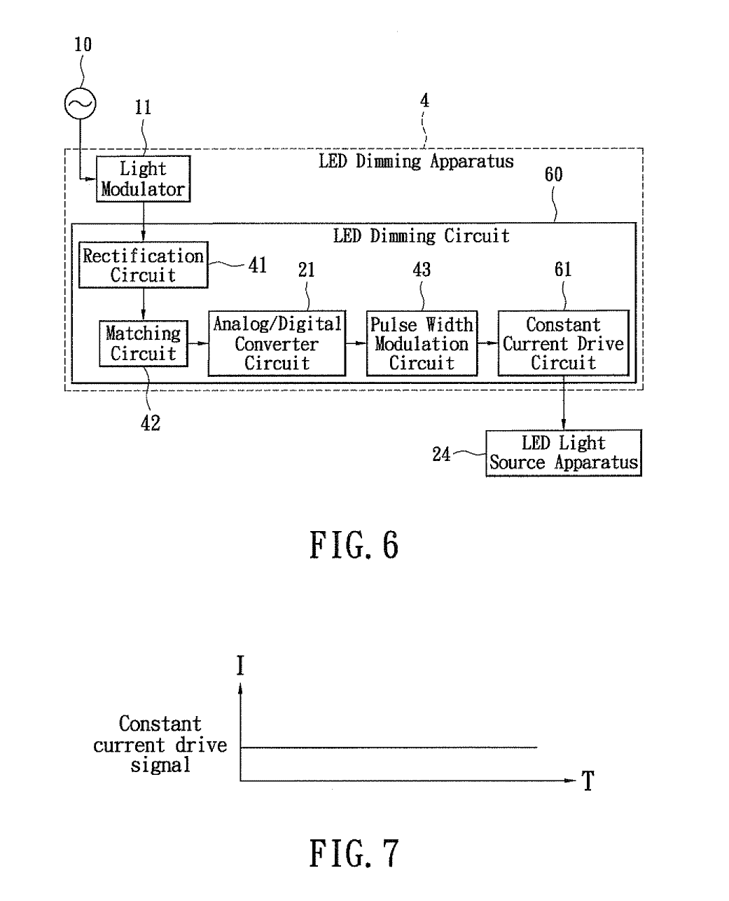

FIG. 6 illustrates a schematic diagram of a second embodiment of the LED dimming apparatus in accordance with the present technique.

FIG. 7 illustrates a signal diagram of the second embodiment of the LED dimming apparatus in accordance with the present technique.

As per the LED dimming apparatus 4 of the second embodiment according to the present invention, the principal elements and the connection relationship thereof are similar with the LED dimming apparatus 3 demonstrated in FIG. 4, wherein the LED dimming apparatus 4 further comprises a constant current drive circuit 61, connected with the pulse width modulation circuit 43 and the LED light source apparatus 24. In other words, the LED dimming circuit 60 includes the rectification circuit 42, the matching circuit 42, the analog/digital converter circuit 21, the pulse width modulation circuit 43 and the constant current drive circuit 61. The constant current drive circuit 61 is one kind of circuits for outputting a constant current and it can modulate the output current value of the constant current drive signal as shown in FIG. 7 based on the pulse width modulation signal of the pulse width modulation circuit 43. As per the above illustrations, as the duty cycle ratio of the pulse width modulation signal is high, the constant current drive circuit 61 outputs a constant current drive signal with higher output current value; as the duty cycle ratio of the pulse width modulation signal is low, the constant current drive circuit 61 outputs a constant current drive signal with lower output current value. Therefore, the constant current drive circuit 61 outputs different current values based on the duty cycle ratio of the pulse width modulation signal, and the LED light source apparatus 24 can modulate illumination brightness thereof according to different output current values of the constant current drive signal. Because the constant current drive circuit 61 outputs the constant current drive signal having a constant current and a high voltage level as shown in FIG. 7, and the high voltage of the constant current drive signal is higher than the operating voltage for the LED light source apparatus 24, the drift for the luminescence spectrum of the LED light source 24 can be prevented and the twinkling issue caused by the pulse width modulation signal switching of the pulse width modulation circuit 43 can be avoided as well. Pursuant to the above illustrations, the LED dimming apparatus 4 of the second embodiment according to the present invention, adapts for the LED light source apparatus 24 for providing a near-by light source, for example, table lamps or the like. It can avoid the twinkling issues caused by the pulse width modulation signal of the pulse width modulation circuit 43. When users apply the light source, the twinkling of the LED light source will not cause uncomfortable for eyes.

The aforementioned descriptions represent solely the preferred embodiment of the present invention, without any intention to limit the scope of the present invention thereto. Various equivalent changes, alterations, or modifications based on the claims of present invention, therefore, are all viewed as being embraced by the scope of the present invention which is fully described fully only within the claims presented here.

What is claimed is:

1. A LED dimming apparatus, comprising:
a light modulator, connected with a AC power source, for receiving a AC power signal and generating a dimming signal;
a rectification circuit, connected with the light modulator, for receiving the dimming signal and rectifying the dimming signal to generate a rectification signal;
a matching circuit, connected with the light modulator, for receiving the rectification signal and matching the rectification signal to generate a matching signal respectively;
an analog/digital converter circuit, connected with the matching circuit, for receiving the matching signal and converting the matching signal to form a conversion signal with positive half cycles of a sinusoidal waveform; and
a pulse width modulation circuit, connected with the analog/digital converter circuit, for receiving the conversion signal, generating a modulation signal according to the conversion signal, and transferring the modulation signal to a LED light source apparatus so as to drive the LED light source apparatus emitting light.

2. The LED dimming apparatus according to claim 1, wherein the light modulator is a SCR or a TRIAC.

3. The LED dimming apparatus according to claim 1, wherein the matching circuit performs full-wave rectification to convert the rectification signal to the matching signal, and the matching signal has the same duty cycle and the same maximum output voltage level of the rectification signal.

4. The LED dimming apparatus according to claim 1, wherein the matching signal has the lowest output current value which is fixed at the output current value with a conduction angle greater than zero degree.

5. The LED dimming apparatus according to claim 4, wherein the lowest output current value is higher than the lowest operation current value of the analog/digital converter circuit or the pulse width modulation circuit.

6. The LED dimming apparatus according to claim 1, wherein the conversion signal has the same duty cycle and the same maximum output voltage level of the matching signal.

7. The LED dimming apparatus according to claim 1, wherein the pulse width modulation signal has a constant output current value and an output voltage level which is greater than the drive voltage level of the LED light source apparatus.

8. The LED dimming apparatus according to claim 1, further comprising a constant current drive circuit, connected between the pulse width modulation circuit and the LED light source apparatus, for receiving the pulse width modulation signal and outputting a constant current drive signal so as to drive the LED light source apparatus and to adjust the current value of the constant current drive signal based on the ratio adjustment associated with the duty cycle of the pulse width modulation signal.

9. A LED dimming circuit, comprising:
a matching circuit, connected with the light modulator, for receiving a dimming signal of the light modulator and converting the dimming signal to a matching signal;
an analog/digital converter circuit, connected with the matching circuit, for receiving the matching signal and converting the matching signal to form a conversion signal with positive half cycles of a sinusoidal waveform; and
a pulse width modulation circuit, connected with the analog/digital converter circuit, for receiving the conversion signal, generating a modulation signal according to the conversion signal, and transferring the modulation signal to a LED light source apparatus so as to drive the LED light source apparatus emitting light.

10. The LED dimming circuit according to claim 9, wherein the matching circuit performs full-wave rectification to convert the dimming signal to the matching signal, and the matching signal has the same duty cycle and the same maximum output voltage level of the dimming signal.

11. The LED dimming circuit according to claim 10, wherein the matching signal has the lowest output current value which is fixed at the output current value with a conduction angle greater than zero degree.

12. The LED dimming circuit according to claim 11, wherein the lowest output current value is higher than the lowest operation current value of the analog/digital converter circuit or the pulse width modulation circuit.

13. The LED dimming circuit according to claim 9, wherein the conversion signal has the same duty cycle and the same maximum output voltage level of the matching signal.

14. The LED dimming circuit according to claim 9, wherein the pulse width modulation signal has a constant output current value and an output voltage level which is greater than the drive voltage level of the LED light source apparatus.

15. The LED dimming circuit according to claim 9, further comprising a constant current drive circuit, connected between the pulse width modulation circuit and the LED light source apparatus, for receiving the pulse width modulation signal and outputting a constant current drive signal so as to drive the LED light source apparatus and to adjust the current value of the constant current drive signal based on the ratio adjustment associated with the duty cycle of the pulse width modulation signal.

16. A LED dimming method, comprising:
providing a light modulator, for generating a dimming signal;
providing a matching circuit, for generating a matching signal based on the dimming signal and generating the matching signal containing the lowest output current value based on various dimming signals, in which the lowest output current value is fixed at the output current value with a conduction angle greater than zero degree;
providing an analog/digital converter circuit, for generating a conversion signal based on the matching signal which has a conversion signal with positive half cycles of a sinusoidal waveform; and
providing a pulse width modulation circuit, for generating a pulse width modulation signal based on the signal period and the voltage level of the conversion signal so as to drive a LED light source apparatus, wherein the pulse width modulation signal has a constant output current value, so that the LED light source apparatus has a stable luminescence spectrum.

17. The LED dimming method according to claim 16, wherein the matching circuit performs full-wave rectification to convert the dimming signal to the matching signal, and the matching signal has the same duty cycle and the same maximum output voltage level of the dimming signal.

18. The LED dimming method according to claim 16, wherein the conversion signal has the same duty cycle and the same maximum output voltage level of the matching signal.

19. The LED dimming method according to claim 16, wherein the pulse width modulation signal has a constant output current value and an output voltage level which is greater than the drive voltage level of the LED light source apparatus.

20. The LED dimming method according to claim 16, further comprising a constant current drive circuit, connected between the pulse width modulation circuit and the LED light source apparatus, for receiving the pulse width modulation signal and outputting a constant current drive signal so as to drive the LED light source apparatus and to adjust the current value of the constant current drive signal based on the ratio adjustment associated with the duty cycle of the pulse width modulation signal.
